(19) United States
(12) Patent Application Publication
(10) Pub. No.: US 2009/0096575 A1
(43) Pub. Date: Apr. 16, 2009

(54) Vehicle remote access and control apparatus and communications gateway

(76) Inventor: Craig A. Tieman, Westfield, IN (US)

Correspondence Address: DELPHI TECHNOLOGIES, INC., M/C 480-410-202, PO BOX 5052, TROY, MI, 48007, US

(21) Appl. No.: 11/973,716

(22) Filed: Oct. 10, 2007

(51) Int. Cl. H04B 1/38

(52) U.S. Cl. 340/5.62

(57) ABSTRACT

A remote access control and communication gateway for a vehicle includes a vehicle function control mounted on the vehicle and having a receiver and/or transmitter for communicating with a transmitter and/or a receiver carried in a portable key fob. The transmitter generates a signal in response to a user initiated and/or a vehicle initiated and/or a passive distance threshold signal related to a particular vehicle function. A communication gateway is formed between the fob and a user consumer device to establish wireless local area network communication between the fob and the consumer device, such as cell phones, PDA's, personal computers, and home security systems, to enable the vehicle owner to access vehicle status information, command remote engine start or stop, and control vehicle access via the consumer device while maintaining the vehicle proprietary remote keyless entry access control system security.

### BACKGROUND OF THE INVENTION

The present apparatus relates, in general, to remote keyless entry vehicle systems for remotely controlling vehicle functions.

Remote keyless entry systems for vehicles have been available for many years. A key fob carries pushbuttons, which, when depressed, cause a transmitter in the fob to transmit a short range signal to the remote keyless entry system in the vehicle which validates the signal and decodes the particular vehicle function to be executed while sending a signal to the particular vehicle system to effect the desired function control.

Typically, a key fob allows the user to lock and unlock the vehicle doors, open the vehicle trunk, and sound a vehicle alarm or horn in an emergency. However, recent trends in remote vehicle access and control continue to expand beyond the basic short-range, mono-directional remote keyless entry systems toward longer range, bi-directional communication systems or smart fobs, which have many features, including vehicle access, vehicle immobilizer, keyless engine start, panic button, remote start, vehicle locating, and vehicle information polling. These smart devices rely upon direct radio frequency communication between the fob and the vehicle at either 315, 433 or 868 MHz using dedicated communication channels.

It would be desirable to provide an enhanced vehicle remote access and control apparatus which provides an interface to owner-consumer devices, such as cell phones, PDAs, personal computers, home security systems, etc., while maintaining the security features of the remote access key fob system.

### SUMMARY

A remote access and control apparatus for a vehicle function control mounted in the vehicle includes a portable fob, a transmitter and/or receiver carried in the fob for transmitting and/or receiving a signal indicating a vehicle function in response to a user fob initiated a vehicle initiated or a passive distance threshold initiated signal, a receiver in the vehicle and/or fob receiving the signal relating to the vehicle control function, and a communications gateway carried by the key fob for establishing a communications gateway between the key fob and a remote consumer device to enable the user via the consumer device to access vehicle status information and control vehicle functions through the fob.

The apparatus described herein maintains the short range security of a fob-operated remote keyless entry system while providing enhanced security due to the use of wireless local area network transceivers without the need for subscription fees while affording the wider range of human to machine interface capability from various consumer devices, including large color screens, keyboards, printers, Internet access, etc.

### BRIEF DESCRIPTION OF THE DRAWING

The various features, advantages and other uses of the present invention will become more apparent by referring to the following detailed description and drawing in which:

FIG. 1 is a perspective view of a vehicle incorporating a vehicle remote access control apparatus and communication gateway; and

FIG. 2 is a block diagram showing the operating components of the apparatus and communications gateway.

### DETAILED DESCRIPTION

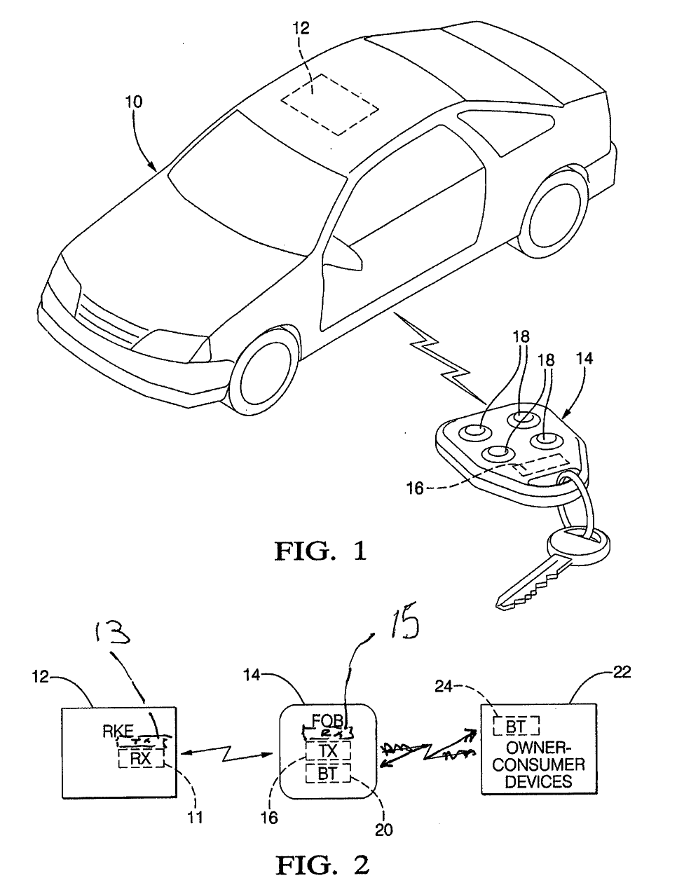

Referring now to FIGS. 1 and 2, there is depicted a vehicle remote access and keyless entry (RKE) control apparatus 12 mounted on a vehicle 10. The apparatus 12 is capable of operating or controlling numerous vehicle functions, such as the locking and unlocking of electric door locks, unlatching the trunk latch, activating or disarming the vehicle security system, etc.

Although the apparatus 12 is described hereafter as being used to control vehicle functions, it will be understood that the control apparatus and communications gateway can be used to control any function in any appropriate system.

The apparatus 12 utilizes a receiver 11 mounted in the vehicle 10 which receives a signal from a remotely located transmitter 16, typically mounted in a portable key fob or fob 14. The fob 14 is depicted, by example only, as being separate from the vehicle key. It will be understood that the fob 14 can also be integrated into the key head.

As is typical, the fob 14 includes a plurality of operable inputs, such as depressible buttons 18, each of which may include indicia to designate a particular controlled vehicle function. The buttons 18 can be used to control the locking and unlocking of the vehicle door locks, unlatching of the vehicle trunk, as well as deactivating a vehicle alarm, etc.

The fob 14 can also include a display, not shown, for generating graphical/text information.

The transmitter 16 typically broadcasts radio frequency signals at a power level dictated by the FCC. The receiver 11 receives the RF signal when the fob 14 is within the broadcasting range of the transmitter 16 is typically 30-100+ meters. The receiver 11 and related circuitry determine the validity of the signal sent by the transmitter 16 for access by the proper transmitter 16 as well as generating signals for controlling the selected vehicle function.

In another example, the RKE 12 in the vehicle 10 can have a transmitter 13 and the fob 14 a receiver 15 only to enable the RKE 12 to send vehicle initiated messages, i.e., an alarm being set off, to the fob 14.

The RKE 12 and the fob 14 can also be a passive entry RKE system wherein the RKE automatically opens or locks the vehicle 10 doors without push button input from the fob 14 when the fob 14 carried by the user crosses a prescribed distance threshold from the vehicle 10.

The RKE 12 and the fob 14 can also

The receiver 11 and the transmitter 16 can also each be transceivers or have a separate transmitter and a receiver respectively associated therewith in the vehicle 10 and in the fob 14 to enable bidirectional communication between the RKE 12 and the fob 14.

As shown in FIG. 2, a short/medium range transceiver 20 is mounted in the fob 14. The transceiver 20 may be a Bluetooth IEEE 802.11 g/b/a/n or Near Field Communication (NFC) transceiver. The transceiver 20 creates a wireless local area network (WLAN) based communication gateway between the vehicle proprietary of remote keyless access and control system and the Bluetooth, 802.11, NFC or equivalently enabled consumer devices 22 which have a similar transceiver 24 operating as a Bluetooth, 802.11 or NFC transceiver.

In operation, the fob 14 retains its functionality of maintaining mono-directional or bidirectional, secure communications with the vehicle 10 while exchanging vehicle access, control and status data with the owner's consumer devices 22. The consumer devices 22 may include a cell phone, PDA, personal computer, home security system, etc.

With the communications gateway provided by the transceivers 20 and 24 and appropriate operating software, combined with executable software on the owner's consumer device 22, the vehicle owner can use the consumer device 22 to access vehicle status information, command remote start or stop and control vehicle access, i.e., lock and unlock vehicle doors. The software application on the consumer device 22 is easily obtained, such as by downloading from media, downloading from the Internet or cell phone service provider, etc.

The present communications gateway eliminates the need for subscription fees required by cellular telephone networks. The larger color screens, keyboards, printers, internet access gateways, on the consumer device 22 can be employed, thereby keeping the cost of the fob 14 low.

What is claimed is:

1. A remote keyless entry apparatus for a vehicle comprising:
a vehicle function control apparatus mounted in the vehicle;
a portable fob;
an RKE transmitter transmitting a signal relating to a vehicle function;
a RKE receiver receiving the signal; and
a communications gateway carried by the fob and a user consumer device for establishing communication between the fob and the consumer device to enable the user to access vehicle status information via the consumer device through the fob.

2. The apparatus of claim 1 wherein the communication gateway includes:
one of a Bluetooth, an 802.11, and a Near Field Communication network.

3. The apparatus of claim 1 wherein the communication gateway includes:
a wireless local area network.

4. The apparatus of claim 1 wherein:
the RKE transmitter is carried in the fob; and
the RKE receiver is mountable in and coupled to the vehicle function control apparatus.

5. The apparatus of claim 1 wherein:
one RKE transmitter and one RKE receiver are mounted in each of the fob and the vehicle control apparatus for bidirectional communication therebetween.

6. The apparatus of claim 1 wherein:
the RKE transmitter is coupled to the vehicle function control apparatus; and
the RKE receiver is carried in the fob.
